(19) United States
(12) Patent Application Publication
(10) Pub. No.: US 2011/0200035 A1
(43) Pub. Date: Aug. 18, 2011

(54) COOPERATIVE EXTERNAL CONTROL OF DEVICE USER INTERFACE USING SIP PROTOCOL

(76) Inventor: Martin T. Sunstrum, Calgary (CA)

(21) Appl. No.: 13/007,662

(22) Filed: Jan. 16, 2011

Related U.S. Application Data
(60) Provisional application No. 61/295,701, filed on Jan. 16, 2010.

(51) Int. Cl. H04L 12/66

(52) U.S. Cl. 370/352

(57) ABSTRACT

Implementations described herein provide the ability for a network telephony device or a computer application device to co-operatively control various user interface elements of another network telephony device that has user interface elements such as a screen, physical and/or touch-screen buttons, and illuminated indicators. Upon a VoIP communication session being set up between two devices, one device can co-operatively modify user interface elements presented on the other device. In response to user input actions on a telephony network device with user interface elements, response messages are sent back to the other device within this communication session via VoIP DTMF responses. To maximize the end user interaction experience, the controlling device can specify to the recipient device what DTMF key responses to send when any non-dialpad keys are pressed.

### CROSS REFERENCE TO RELATED APPLICATIONS

This application claims the benefit of U.S. Provisional Application No. 61295701, COOPERATIVE EXTERNAL CONTROL OF DEVICE USER INTERFACE USING SIP PROTOCOL, filed Jan. 16, 2010, which is incorporated herein by reference.

### BACKGROUND OF THE INVENTION

The background of this invention relates to how an external entity, such as a software application, another device, or other computer system can remotely can co-operatively control the user interface elements of a telephony capable end user device, such as a VoIP phone.

It addresses the rudimentary implementation and significant limitations of existing prior art such as found in US Patent Application 20090154678.

### BRIEF SUMMARY OF THE INVENTION

Voice over Internet Protocol (VoIP) devices and systems are now commonplace. Most end-user VoIP devices will have a user interface that typically includes elements such as a screen, possibly a touch screen, physical buttons and/or virtual buttons on a touch screen, and illuminated indicators such as LEDs. The devices typically present a command DTMF dial pad, along win non-dialpad keys.

There are many instances where it is desirable for external devices or systems to have the capability to control the user interface of a VoIP device. The purpose is to present a customizable user interface, without the need to modify the operating software resident in the VoIP device. Examples are if a VoIP phone would like to navigate through an address book that might be resident on a phone system server, or would like to present a visual list of voicemails available on the server. Once the customized information is presented on the VoIP device, user input on the VoIP device allows a user to navigate a list of information generated on the fly, and make appropriate action selections. This presentation of customized information can be anything to left to one's imagination, including the ability to view weather reports, stock information, etc. . . .

Many VoIP phones can accomplish this today via use of a HTTP-based XML browser resident in the VoIP phone. Content is requested by a VoIP phone, via a HTTP request, and content, commonly in XML or web page format is rendered and delivered by an external system.

This HTTP method provides acceptable in many situations, but has several drawbacks in many other situations. For simple content delivery it is sufficient, but in many cases integrators want to deliver customized content based on phone and end user specific events. This action events could be such items as pressing a feature key, going off hook, going on hook, putting a call on hold, accepting a second call, receiving an incoming call, initiating an outgoing call, upon a call being connected, when the phone is in an idle state, and other like actions. To provide this type of user interface control via the HTTP method, the VoIP phone software requires deep modification to hook in the various points where the VoIP phone will need execute a HTTP request. This type of software modification is intrusive and difficult to implement and not well standardized by various VoIP phone vendors.

This HTTP method is completely independent from a VoIP phones underlying control protocol, which is commonly the Session Initiation Protocol (SIP). In a SIP session, where media can be real-time audio and/or video media streams, it becomes very difficult to make the HTTP method leverage any integration to do with the media streams.

Take for instance, take the example of a user of a VoIP phone, who wants to review voicemails stored on a central phone system server. Using HTTP methods, it is common to see implementations to allow a user to navigate and review a list of voicemails present on the central phone system server. The user presses a button, which initiates a HTTP request to a central phone system server. The server returns a formatted list of entries. The user selects an entry, thereby initiating another HTTP request, and then the central phone server or VoIP phone initiates a SIP call between themselves to allow the user to listen to the actual voicemail via a SIP session audio media stream.

The above voicemail scenario is somewhat acceptable, but has many limitations. There is a significant amount of HTTP and SIP activity to perform this, which burdens both software developers of the VoIP device, and software developers on the central phone system server. The co-ordination of two protocols, HTTP and SIP becomes cumbersome. Also, in situations where security and encryption is important, it would be necessary to encrypt both protocols, incurring more software overhead.

The invention described herein, provides a more flexible customized content control, but using just the SIP protocol. When a SIP call is initiated, and once connected, then media, be it audio and/or video, are established between two SIP devices. As known to one skilled in the art, dial pad key presses are relayed back to the other SIP device via packets encoded with DTMF information.

Now we will look at this invention, with the same voicemail scenario example. A user of a VoIP phone initiates a voice call, via SIP protocol, to his central voicemail server to listen to his voicemails, as is normally done when calling in to listen to voicemail messages on a central Internet Protocol based central phone system server. Once the SIP call session is established, audio, and possibly video streams flow between the user of the VoIP phone, and the central phone system server. Typically, the user is required to enter DTMF dialpad entries to navigate audibly through a list of voicemails. There is no textual or graphical representation of voicemail entries presented when the SIP call session is established.

The invention described herein, allows the central phone system server to send special user interface control (UI-CTL) SIP messages on the same dialog as the established SIP session. Various UI-CTL SIP message(s) sent from the central phone system server allow textual or graphical content to be displayed on the end user VoIP device. This way, a selection of voicemail entries can be presented. A very important innovation though, is that in these UI-CTL SIP messages, one can specify DTMF keys to be sent upon the end user of the VoIP phone pressing keys other than the regular DTMF dialpad keys. This is important to improve the end user experience, because many end user VoIP devices have many other non-dialpad keys, such as left, right, up, down navigation keys, softkeys, virtual keys displayed on a touchscreen, and various other keys. These UI-CTL SIP messages are simple messages that convey display information that completely or partially display on the screen in a co-operative manner on the end user VoIP device.

The power of this customization of DTMF responses can be seen in contrast to a prior art example, such as US Patent Application 20090154678. In the 20090154678 application, the end user of the VoIP device is restricted to only entering in regular DTMF dialpad entries. That severely limits the friendliness of the user interface, and occupies a lot of precious screen area just to indicate which DTMF key entries will be acted upon. In the 20090154678 application FIG. 4, they show a phone with a whole range of non-dialpad keys, but those keys cannot be used in the interactive session.

For the invention described herein, and in reference to the above voicemail example, the central phone server sends UI-CTL SIP messages on the same dialog as the established media SIP session. This UI-CTL SIP message can specify what DTMF keys are to be sent upon an end user of the VoIP phone pressing various non-dialpad keys on the VoIP phone. For example, if a VoIP phone device has four navigation keys (left, right, up, down) and an OK button, the UI-CTL SIP message could comprise information that tells the VoIP phone device to send one or more specific DTMF key values for each of these non-dialpad keys. With this innovation, a much richer user interface experience is possible, since the end user is not limited to pressing just regular DTMF dialpad entries. One or more UI-CTL SIP messages can also describe textual or graphical information that is rendered by the end user VoIP device.

In reference to the prior art US Patent Application 20090154678, it is also important note that these UI-CTL messages are sent in-dialog with the existing SIP session. This is important, because a VoIP device may be involved in a multitude of SIP sessions simultaneously. An end user of a VoIP device may put one session on hold, and accept another new session. The remote entities may be sending UI-CTL messages, and the SIP dialog information in the UI-CTL will allow the application on the end user VoIP device to know what SIP communication session the UI-CTL messages are associated with. Application 20090154678 only allows one session at a time, and does not allow any method for the end-user to manage multiple VoIP sessions simultaneously.

In reference to prior art, Application 20090154678 indicates that it is the callee who is generating the user interface control messages. The invention described in this document allows either the caller or callee, or both to be actively sending user interface control messages.

In reference to prior art, Application 20090154678 also does not provide any ability for the user interface control messages to control other user interface elements on a VoIP device such as LEDs. The invention described in this document allows control of indicators such as LEDs, or graphical elements that may be rendered on a display screen.

In contrast to the HTTP method used on many VoIP phones, the inventive methods allow much simpler implementation of a flexible user interface control, and allow tight integration with media streams such as audio or video. This dramatically simplifies the implementations both on the end user display device, and the device, application or system generating the user interface content.

The present disclosure is directed to overcoming one or more of the problems associated with allowing co-operative user interface control of an end user VoIP device.

### BRIEF DESCRIPTION OF THE DRAWINGS

FIG. 1 is a representation of an exemplary Device 118 with a non-touchscreen user interface;

FIG. 2 is a representation of an exemplary Device 140 with a touchscreen user interface;

FIG. 3 is a an exemplary Device UI Interface 300, focussed on the screen display area of Device 118 and exhibiting a external controlled network address book application;

FIG. 4 is a representation of an exemplary Internet Telephony SIP environment 400;

FIG. 5 is a representation of an exemplary disclosed SIP connected state call flow diagram 500 between two SIP user agents in a simple IP network;

FIG. 6 is a representation of an exemplary disclosed SIP connected state call flow diagram 600 between two SIP user agents in a more complex IP network that includes elements such as a back-to-back user agent (B2BUA);

FIG. 7 is a representation of an exemplary disclosed SIP provisional state call flow diagram 700 between two SIP user agents;

FIG. 8 is a representation of an exemplary disclosed SIP idle state call flow diagram 800 between two SIP user agents;

FIG. 9 is a an exemplary Device UI Interface 900, focussed on the screen display area of Device 118 and exhibiting a default SIP connected state user interface display;

FIG. 10 is a an exemplary Device UI Interface 1000, focussed on the screen display area of Device 118 and exhibiting a default incoming call SIP provisional state user interface display;

### DETAILED DESCRIPTION OF PREFERRED EMBODIMENTS

Reference will now be made in detail to the exemplary preferred embodiments implemented according to the disclosure, the examples of which are illustrated in the accompanying drawings. Wherever possible, the same reference numbers will be used throughout the drawings to refer to the same or like parts.

Exemplary embodiments include a method and system for implementation of an inventive system and methods to allow another device to cooperatively control the user interface elements of a second device. Exemplary embodiments include devices communicating over an Internet Protocol (IP) network using the Session Initiation Protocol (SIP) communication protocol between the two devices. The SIP protocol is well known to one skilled in the art, and IETF RFC3261 is one of the RFC documents that describe this protocol. Each device incorporates a SIP user agent, as is known to one skilled in the art. When the devices are idle, or are in the process of establishing a SIP communication session, or are already in an established SIP communication session, either device's SIP user agent can send user-interface control (UI-CTL) messages to the other device's SIP user agent.

Upon a SIP user agent receiving a UI-CTL message, the recipient SIP user agent can decide to act upon the message to modify any operation in its user interface. The UI-CTL message can control what textual or graphical information that is displayed on a device's screen, can modify what action is taken when a recipient's keys, whether real, or virtual as shown on a touchscreen, are subsequently pressed, and can modify the display characteristics indicators, whether real or virtual on the recipient device screen. These indicators would include such things as LEDs on a device, or a virtual indicator rendered on a screen. The display characteristics would cover such items as color, blinking cadences that would be visually noticed by a user.

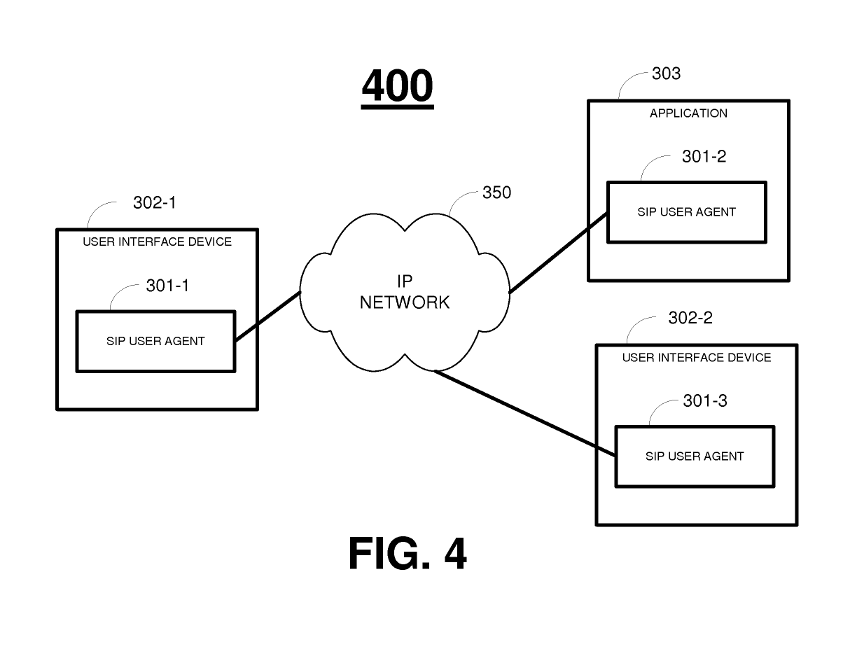

FIG. 4 shows an exemplary Internet Telephony SIP environment 400. The SIP environment 400 can be comprised of two or more SIP User Agents 301 that establish TCP/IP communications through an IP Network 350. IP Network 350 is a standard TCP/IP communication network which could simply be network switches, or include complex elements such as firewalls, routers, NATS, wireless links, proxy servers, back to back user agents and any other such network devices known to one skilled in the art. No matter the simplicity or complexity of IP Network 350, it will route SIP messages between two SIP User Agents 301. As part of a connected SIP communication session, the Real-time Transport Protocol (RTP) is also inferred to be part of the communication session, as is known to one skilled in the art. This RTP session can handle both audio and video transport between the two SIP User Agents 301.

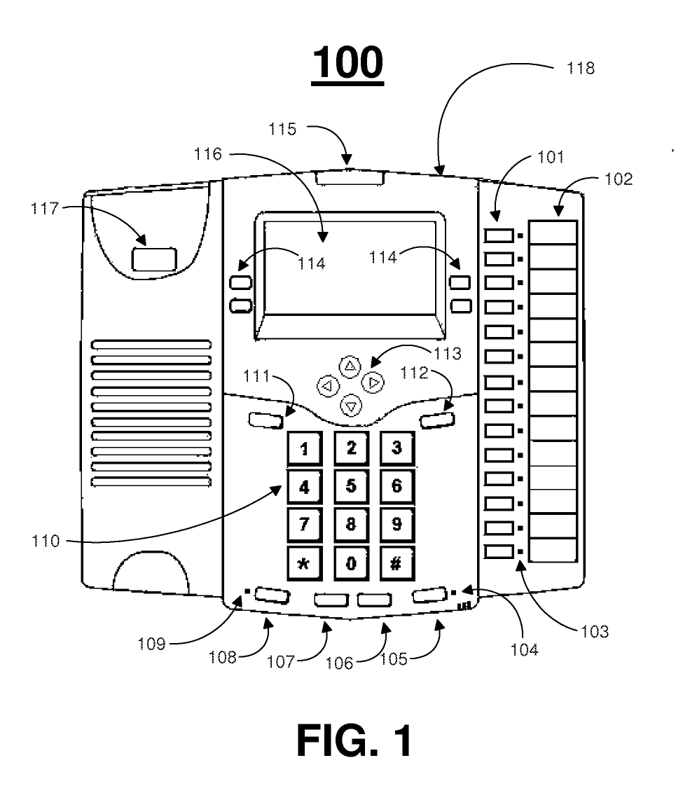

User Interface Device 302-1 (and 302-2) represents an electronic device that has some level of user interface on it, which may include such elements as a screen, buttons and indicators such as LEDs. FIG. 1 shows an exemplary User Interface 100. This User Interface 100 would be representative of a typical business desk phone. It could include such user interface elements such as a display screen 116, a ringing and/or message waiting LED indicator 115, various programmable feature keys 101, various feature key indicator LEDs 103, a feature key paper label or display LCD 102, a speaker and/or headset key 104, along with an indicator LED 104, volume keys 106 and 107, a mute key 108, along with an indicator LED 109, a dialpad 110, a hold key 111, a release key 112, navigation keys 113, screen softkeys 114 and a hookswitch key 117.

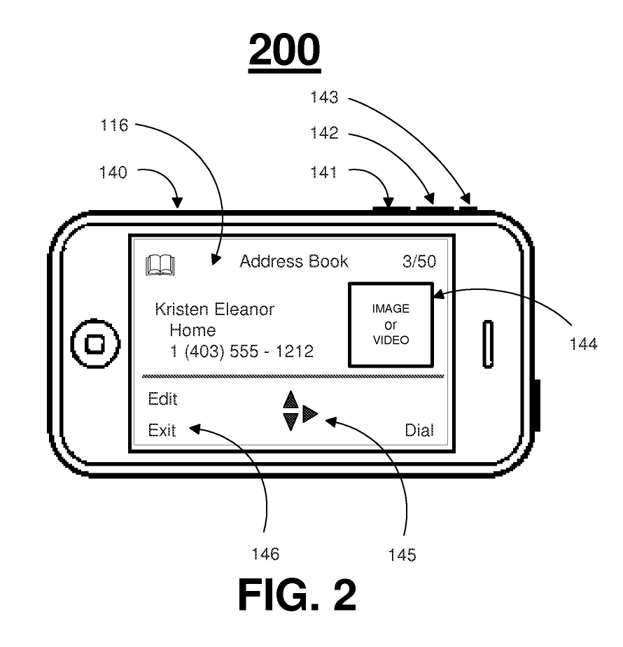

To one skilled in the art, it is recognized that a User Interface Device 302-1 could be realized in many different manners, and the above description is just a representative example. For example, an alternative representation of User Interface Device 302-1 can be found in FIG. 2 as alternative User Interface 200. This User Interface 200 would be representative of a typical touchscreen device. It could include such user interface elements such as a display screen 116, it may have external hard buttons such as 141, 142 and 143, which may be device and/or context specific functions such as volume control, or ringing mute functions. Rendered on the display screen 116 would be display elements softkeys 146, navigation keys 145, and an image or video portion 144 of the screen.

In the inventive system, at least one of the SIP User Agents 301 must be part of a User Interface Device 302. The other end of the SIP communication could be another User Interface Device 302, or it could be an entity which has no user interface, such as an Application 303.

An Application 303 would represent an entity that does not have any user interface, but rather would be a software application that communicates to the User Interface Device 302-1 via its own SIP User Agent 301-2. Typical examples of an Application 303 known to one skilled in the art would include a PC application, and private branch exchange server (PBX), an interactive voice response (IVR) system, a voicemail system, a generic embedded electronic system, and other similar systems that have been designed with an embedded SIP User Agent 301.

The SIP User Agents 301 communicate using the Session Initiation Protocol (SIP) protocol, but one skilled in the art will appreciate that the disclosure could be implemented using other VoIP protocols, e.g., H.323 or other packet-signalling VoIP telephony protocols known in the art.

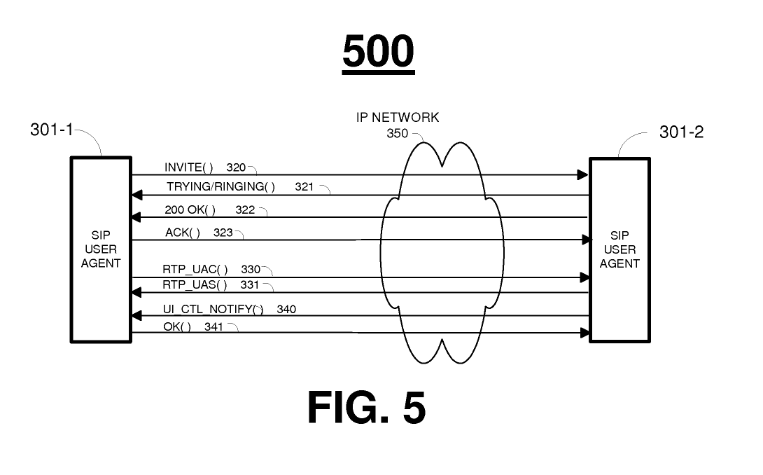

FIG. 5 shows an exemplary SIP call flow diagram 500 for Internet Telephony SIP environment 400. First, a user of Device 302-1 makes a standard SIP telephone call to Application 303 over the IP Network 350. As shown in FIG. 5, a SIP INVITE( ) 320 message is sent from SIP User Agent 301-1 with the destination SIP address of Application 303. (e.g., addressbook@192.168.0.50) via the IP Network 350 and arrives at SIP User Agent 301-2. As known to one skilled, in the art, a connected SIP communication is established according to the proper sequence of Trying/Ringing( ) 321, 200 OK( ) 322 and ACK( ) 323 messages being exchanged. With the establishment of the SIP session, now each SIP User Agent 301-1 and 301-2 can exchange RTP via RTP_UACO 330 and RTP_UAS( ) 331. This RTP packet data can include audio and/or video data.

After the SIP communication session is established, SIP User Agent 301-2 can now send a standard SIP NOTIFY message, shown in FIG. 5 as UI_CTL_NOTIFY( ) 340 message, which conveys desired user-interface (UI) textual, graphical, key press information and/or indicator information to render on Device 301-1. This UI descriptive content may be specified in a XML markup format, for example, placed in the content header body of the UI_CTL_NOTIFY( ) 340 message. Upon reception of UI_CTL_NOTIFY( ) 340 message by SIP User Agent 301-1, it can validate and accept the event type and content of the NOTIFY( ) 340 message by sending back to SIP User Agent 301-2 a 200 OK( ) 341 message. As is known to one skilled in the art, if SIP User Agent 301-1 does not support the event type, or doesn't like the content of the UI_CTL_NOTIFY( ) 340 message, it can send back an appropriate 4xx SIP error code to SIP User Agent 301-2.

In a preferred embodiment the SIP call flow diagram 500, it is recommended that no SUBSCRIBE SIP message is required from SIP User Agent 301-1 to initiate the reception of UI_CTL_NOTIFY( ) 340 message. The reason for this is that this UI-CTL session is established upon each SIP call, and a SUBSCRIBE would add an unnecessary amount of overhead. But it is imperative that the UI_CTL_NOTIFY( ) 340 message is sent, as is known to one skilled in the art, “in dialog” to the original INVITE( ) 320 message transaction. The reason for this is that Device 302-1 could be managing multiple SIP User Agents, such as SIP User Agent 301-1 at the same time, and hence that Device 302-1 may be managing multiple simultaneous user interface sessions. By having the UI_CTL_NOTIFY( ) 340 message “in dialog” to the original INVITE( ) 320 message transaction allows Device 302-1 to associate the UI_CTL_NOTIFY( ) 340 to the proper SIP call session. It is understood by one skilled in the art, that if the Application 300 is unable to send the UI_CTL_NOTIFY( ) 340 message “in dialog”, the less preferred method, would be for Application 300 to send the UI_CTL_NOTIFY( ) 340 message “out of dialog”. But in this case, the content body of the UI_CTL_NOTIFY( ) 340 message would need to additionally convey the appropriate SIP session dialog identification information. This identification information would include appropriate dialog identification information such as the SIP To, From, tags, Call-ID header fields. This would allows Device 302-1 to match this “out of dialog” UI_CTL_NOTIFY( ) 340 message to the appropriate SIP call session.

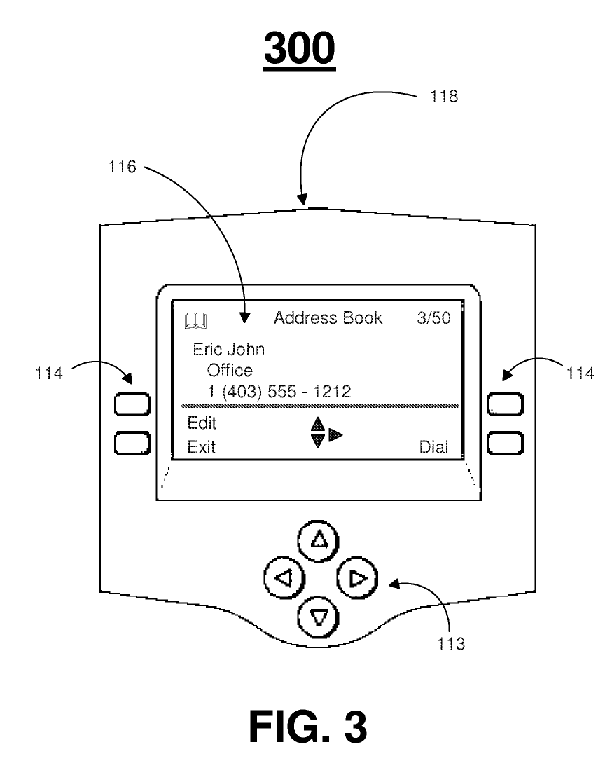

Upon reception and acceptance of UI_CTL_NOTIFY( ) 340 message by SIP User Agent 301-1, it can now parse the Content Body of the UI_CTL_NOTIFY( ) 340 message, and render this UI information properly on Device 302-1. The following is an exemplary example of the UI_CTL_NOTIFY( ) 340 message, including its Content Body. Note that this information could be sent across multiple UI_CTL_NOTIFY( ) 340 messages, and not all information elements need to be the same for each UI_CTL_NOTIFY( ) 340 message. For explanation purposes, it is shown as a single message. As an example, this UI_CTL_NOTIFY( ) 340 message could be rendered Device UI Interface 300 as shown in FIG. 3.

NOTIFY sip:200@192.168.0.31:5060 SIP/2.0
From: “addressbook” <sip:addressbook@192.168.0.50>;tag=as0ddc02b6
To: “Joe”<sip:200@192.168.0.50>;tag=d740dc17
Call-ID: eb177059a501c008
CSeq: 102 NOTIFY
Event: ui-ctl
User-Agent: myUA
Content-Type: text/plain;charset=UTF-8
Content-Length: xxx
<root;screen=overlay>

<Display>

<Text>$BOOK$ Address Book 3/50</Text>
<Pos>2,0</Pos>

</Display>
<Display>

<Text>Eric John</Text>
<Pos>5,25</Pos>

</Display>
<Display>

<Text>Office</Text>
<Pos>15,35</Pos>

</Display>
<Display>

<Text>1(403)555-1212</Text>
<Pos>15,45</Pos>

</Display>
<Line>

<Pos>0,53,128,1</Pos>

</Line>

<Display>

<Text>Edit</Text>
<Pos>2,55</Pos>

</Display>
<Display>

<Text>Exit</Text>
<Pos>2,65</Pos>

</Display>
<Display>

<Text>Dial</Text>
<Pos>55,65</Pos>

</Display>
<Display>

<Text>$ARROWS_3A$</Text>
<Pos>32,60</Pos>

</Display>
<LED>

<Item>F1</Item>
<Cadence>400,100</Cadence>
<Color>Green</Green>

</LED>
<Keys>

<Key>SOFTKEY_UL,DTMF_RFC2833,1</Key>
<Key>SOFTKEY_BL, DTMF_RFC2833,4</Key>
<Key>SOFTKEY_BR, DTMF_RFC2833,6</Key>
<Key>NAV_RIGHT, DTMF_INFO,9</Key>
<Key>NAV_UP, DTMF_ INFO,5</Key>
<Key>NAV_DOWN, DTMF_INBAND,8</Key>
<Key>F5, TRANSFER,7</Key>

</Keys>

</root>

The following will provide a description of the purpose of each XML element in this Content Body.

Element: <root></root>

This simply represents the end and the start of the XML body, for parsing purposes. The screen=overlay parameter indicates this is a full screen overlay over the default connected SIP session screen that Device 302-1 would normally render. For example, screen=update may be used to update a portion of the screen.

### Element: <Display></Display>

The <Text> element represents a textual string to be rendered on the screen 116, along with the X and Y location co-ordinates on the screen. In this examples, character-based display icons, which are device/implementation specific can be supported. $BOOK$ represents a book character-based icon.

### Element: <Line></Line>

This represents a line to be drawn on the screen, along with the starting X and Y location co-ordinates on the screen, it's pixel length, and pixel height.

### Element: <LED></LED>

This represents that a LED indicator is to be have its operation changed. <Item> specifies which LED. In this case F1 may represent the first feature key LED, as represented in FIG. 1, LED 103. <Cadence> would specify the on/off time in milliseconds. If on value equals 0, the LED would be off. If on value is non-zero, and off value is 0, then the LED would be on. If both on/off values are greater than 0, then the LED would blink at that specified cadence. The <Color> value would specify the color to use for the LED, assuming it is a multi-color LED.

### Element: <Keys></Keys>

This represents a key inventive concept in the operation of Device 302-1. Devices as shown in FIG. 1 and FIG. 2 have many keys, real or virtual, beyond just a standard dialpad, as represented in FIG. 1 dialpad 110. These would be keys such as navigation keys 113 or softkeys 114 or virtual navigation keys 145 or virtual softkeys 146. As known to one skilled in the art, when in an established VoIP SIP communication session, keypad presses on dialpad 110 on Device 302-1 would send a DTMF digit via its SIP User Agent 301-1 to SIP User Agent 301-2, and this would be reported to Application 303. Any other key presses on Device 302-1 are consumed internally by the software application resident in Device 302-1. Application 303 would not know that any non dialpad keys were pressed. But this severely restricts the flexibility of the end user experience on Device 302-1, and how the user interface can be remotely controlled via Application 303. Hence, the innovation of the <Key> value is that it allows the Application 303 to convey to Device 302-1 a request that certain key press events to be reported back to Application 303. In this exemplary example, <Key> would specify three pieces of information. The first would be a key identifier, which specifies a key identifier, an action to take, and a value associated with that action. A key identifier could include any regular dialpads key and non-dialpad keys.

For example, <Key>SOFTKEY_BL, DTMF_RFC2833,4</Key> would indicate that when the bottom left softkey is pressed, that Device 302-1 would send DTMF value of 4, using the DTMF RFC2833 method, as is known to one skilled in the art. Note that in this example, more than one DTMF digit could be specified, and they are can even include extended DTMF values, such as A,B,C,D as is known to one skilled in the art.

It is quite common for DTMF digits to be conveyed by the RFC2833 method, and that is normally negotiated between two SIP User Agents when the SIP communication is established. Known to one skilled in the art, these would be negotiated to use RFC2833, INFO or in-band methods in SIP INVITE( ) 320 and 200 OK( ) 322 messages. The <Key> action entry allows Application 303 to effectively override what DTMF method is used for dialpad keys. Any other keys not specified in <Keys> would continue their default behaviour on Device 302-1.

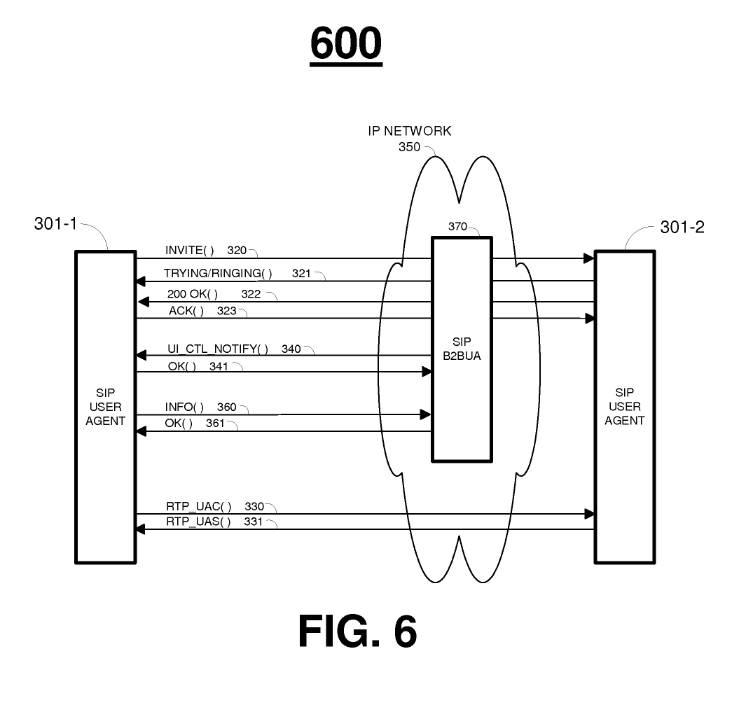

FIG. 6 represents an example of where the above capability would be useful. Known to one skilled in the art, the SIP B2BUA 370 (back to back SIP user agent) would be an example of Application 303. In this scenario, there are multiple SIP User Agents. The audio and/or video streams in the established SIP communication session would be carried between the two SIP User Agents 301-1 and 301-2 using the RTP streams RTP_UAC( ) 330 and RTP_UAS( ) 331. RFC2833 DTMF transport is specified to be transported in RTP streams. Hence, Application 303, such as SIP B2BUA 370 would not be able to know if any key presses occurred on Device 302-1. In FIG. 6 though, if the B2BUA 370 is acting as Application 303, and it wants to know when certain dialpad and/or non-dialpad keys are pressed on Device 302-1, then it would be required to specify in the <Key> field of the UI_CTL_NOTIFY( ) 340 message to report the desired keys using DTMF_INFO method. For example, <Key>NAV_RIGHT, DTMF_INFO,9</Key>. Known to one skilled in the art, DTMF_INFO messages are conveyed via a SIP INFO message, and would flow from SIP User Agent 301-1 to the SIP B2BUA 370.

Note that Application 303 can send a new UI_CTL_NOTIFY( ) 340 message at any time. In many cases it would send a new UI_CTL_NOTIFY( ) 340 message based upon receiving a DTMF event from SIP User Agent 301-1.

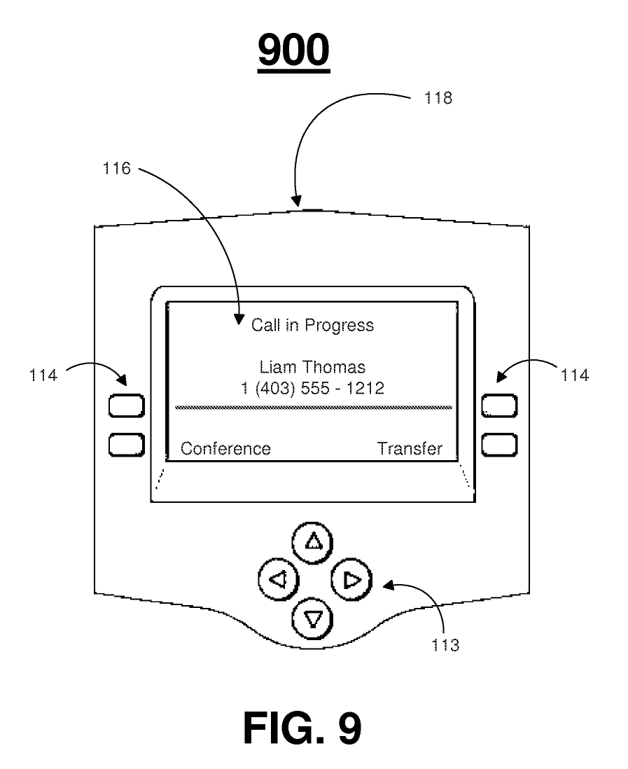

FIG. 3 shows an exemplary example of a portion of a Device UI Interface 300 of Device 302-1, where the user interface is being remotely controlled by Application 303. Screen 116 shows an address book application that has been implemented by Application 303, and rendered by Device 302-1. Note that this Device 302-1, which is designed to handle SIP communication sessions, would normally have a default UI display for a connected SIP communication session. This exemplary sample shows a case where the UI_CTL_NOTIFY( ) 340 message completely overwrote the full display area. FIG. 9 may represent an exemplary example of what the default UI screen 116 on Device 302-1 may look like in a regular connected SIP session. In FIG. 9, it simply shows some caller identification information, with some softkey options for initiating a conference call and call transfer. Those skilled in the art of embedded systems design will understand how to design a screen management interface to handle full or partial screen updates.

Referencing the previously full SIP message format of the UI_CTL_NOTIFY( ) 340 message, one can now envision how key presses, both dialpad, and non-dialpad keys would be reported back to Application 303. For example, referencing FIG. 3, if a user of Device 302-1 presses the down arrow navigation key, a specified DTMF key value(s) would be reported to Application 303. Application 303 decides what to do upon reception of these DTMF key value(s). It could decide to shown the next entry in the address book by sending a new UI_CTL_NOTIFY( ) 340 message. If for example a user of Device 302-1 presses the bottom left softkey, labelled as Exit, a specified DTMF key value(s) would be reported to Application 303, and Application 303 could decide to exit the address book application by sending a SIP BYE message to SIP User Agent 301-1. Note that the specified UI information in UI_CTL_NOTIFY( ) 340 message would expire once the SIP communication session between Device 302-1 and Application 303 has terminated. Device 302-1 would then return to whatever idle user interface display it would have when no established SIP communication session is in progress.

Note that the during a call session, if Application 303 desires Device 302-1 to return to its default screen 116 presentation, the preferred method of doing this is to send a UI_CTL_NOTIFY( ) 340 message with an empty Content Body. Having this functionality would allow Application 303 to implement momentary screen pops on Device 302-1.

Note that the <Key> identifier in the UI_CTL_NOTIFY( ) 340 message can incorporate actions beyond just DTMF key presses. The defined actions can be expanded to include a multitude of imaginative actions that are executed solely by Device 302-1, or include actions that initiate other SIP protocol requests such as BYE, INVITE, REFER, NOTIFY, etc. . . .

For example, if Application 303 is an Asterisk PBX implementation, as is known to one skilled in the art, the Asterisk PBX may want to send a UI_CTL_NOTIFY( ) 340 message to Device 302-1 to add a Call Park softkey to Screen 116 of Device 302-1. Note that for an Asterisk PBX, for Device 302-1 to park a call, Device 302-1 is required to perform an attended transfer SIP message sequence to a predefined call park extension number on the Asterisk PBX. For example, FIG. 9 may represent an exemplary example of what the default UI screen 116 on Device 302-1 may look like in a connected SIP session, when no UI_CTL_NOTIFY( ) 340 message has been yet received from Application 303. If Application 303 would like to add a Call Park softkey, it can send a UI_CTL_NOTIFY( ) 340 message that includes information such as:

<Display>

<Text>Call Park</Text>
<Pos>40,55</Pos>

</Display>
<Keys>

<Key>SOFTKEY_UR,ATTENDED_TRANSFER,700@192.168.0.50</Key>

</Keys>

In this exemplary example, this UI_CTL_NOTIFY( ) 340 message would not overwrite the complete Screen 116, but would rather add a Call Park softkey to the upper right softkey of Device 302-1. When a user presses this upper right softkey on Device 302-1, it would initiate an attended SIP call transfer to the SIP address 700@192.168.0.50, as is known to one skilled in the art. This is a powerful innovation that allows tremendous flexibility for Application 303, in this example, acting as an Asterisk PBX, to extend the default user interface functionality of Device 302-1.

The extensibility of these <Key> functions provide a powerful capability for Application 303 to cooperatively control the user interface Device 302-1, all using the standard SIP communications protocol. This is contrasted to other systems where either the user interface on Device 302-1 cannot be controlled, or if there is some user interface control, it is implemented with a hybrid of other TCP/IP protocols such as HTTP. Coordinating a user interface experience can be difficult for application developers when there is a multitude of TCP/IP networking protocols in use. The methods of our invention is a powerful inventive concept for application developers who want to extend the functionality of user interface devices such as Device 302-1, using the same SIP protocol used to set up the call session. The ability to tightly couple the user interface experience, in synchronicity with the SIP messaging and RTP streams is highly desirable.

It is noted that when Application 303 receives DTMF key events from Device 302-1, that in addition to sending additional UI_CTL_NOTIFY( ) 340 messages, Application 303 can also manipulate the audio and/or video RTP payloads being delivered to and from Device 302-1. This can be useful a variety of different implementations of Application 303.

For example, if Application 303 acts as a voicemail server, to one skilled in the art, it can now be seen how a visual voicemail application can be delivered to Device 302-1. A user of Device 302-1 can make a SIP call to the voicemail application, and when connected, the voicemail application would send UI_CTL_NOTIFY( ) 340 messages to Device 302-1, and respond to DTMF events sent by Device 302-1. For example, if the voicemail server renders a list of voicemail entries, a selection scheme, and finally a “Play” softkey on Device 302-1, and the user of Device 302-1 presses a “Play” softkey, the voicemail server can start streaming a new RTP stream from an audio file stored on the voicemail server. Conversely, to one skilled in the art, the voicemail server can present a user interface to Device 302-1 that would allow simple message forward and reverse options to be presented on the Screen 116 of Device 302-1. Once these forward or reverse key options are pressed on Device 302-1, the voicemail server would forward or reverse its RTP streaming position of the stored audio file.

The above examples are a representation of some of the possible UI control actions that could be supported. Those skilled in the art will appreciate that this may be implemented in a variety of ways other than the XML description above, and may not cover off all possible UI actions that are possible. In particular, a more efficient XML schema may be deployed, in situations where a system would want to fit this UI_CTL_NOTIFY( ) 340 message into one TCP/IP UDP packet. In addition, other SIP message types, and or fields could be used, or other TCP/IP packet protocols than SIP could be used. In addition, elements such as <Display> can be enhanced to support display modifications of rich screen presentations, such as those rendered in HTML. As an alternative example, the <Display> attributes could be enhanced to allow modify any Document Object Model (DOM) element within a rich HTML screen presentation. The original HTML screen content can be resident in Device 302-1, or it could be requested via HTTP protocols, or finally, delivered to Device 302-1 via various enhancements to the UI_CTL_NOTIFY( ) 340 message.

The next inventive concepts for remote control of a device user interface in Internet telephony SIP environment 400 is the fact that the user interface of Device 302-1 can also be controlled outside of a connected SIP communication session.

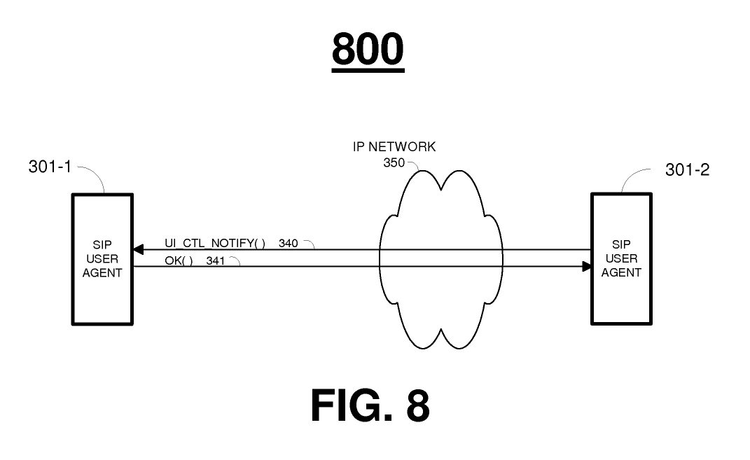

FIG. 8 shows an exemplary SIP message flow example of user interface control when there is no established SIP call connection between SIP User Agents 301-1 and 301-2. This is called an idle state.

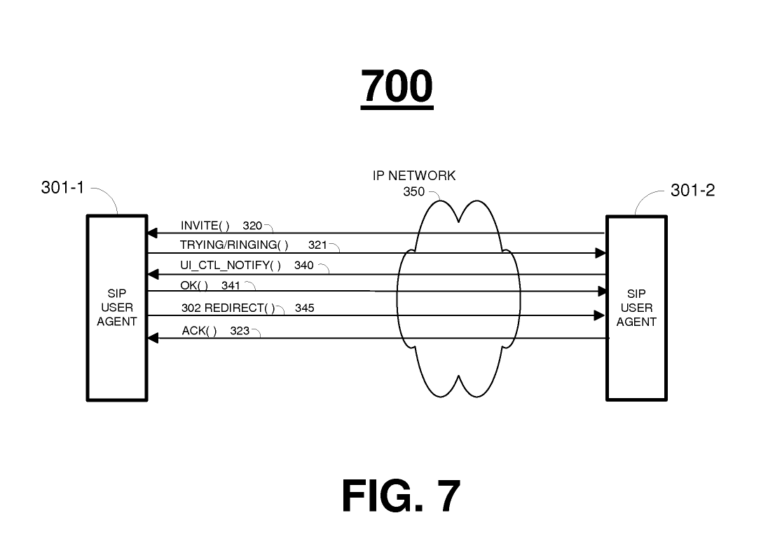

FIG. 7 shows an exemplary SIP message call flow example of user interface control when there is, known to one skilled in the art, an early or provisional SIP call connection state between SIP User Agents 301-1 and 301-2. This is called a provisional state. The following is an scenario explanation of where this is useful when the SIP User Agents 301-1 and 301-2 are in a provisional state. In FIG. 7, it is noted that the UI_CTL_NOTIFY( ) 340 message(s) are sent before the INVITE( ) 320 message receives a final response from SIP User Agent 301-1.

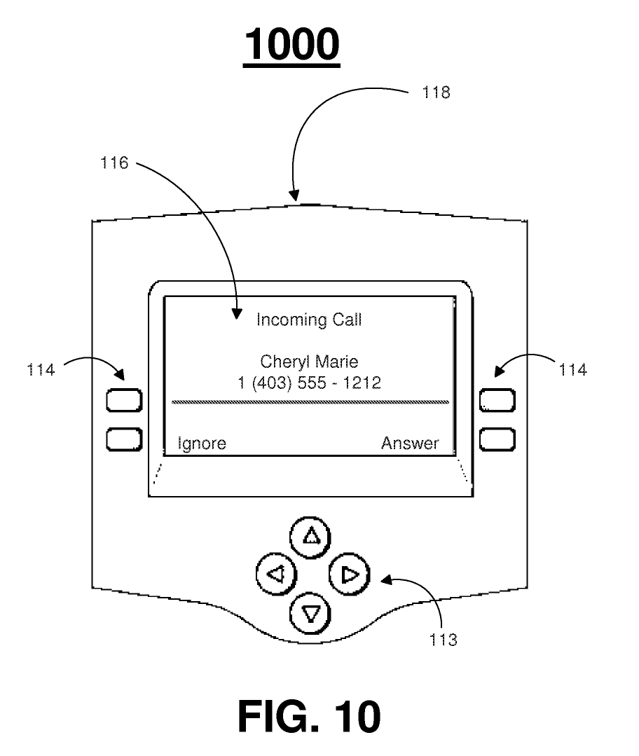

For example, if Application 303 is an Asterisk PBX implementation, as is known to one skilled in the art, the Asterisk PBX may want to send a UI_CTL_NOTIFY( ) 340 message to Device 302-1 during this provisional to add a Voicemail redirection softkey to Screen 116 of Device 302-1. Note that for an Asterisk PBX, for Device 302-1 to redirect an incoming SIP call to voicemail, Device 302-1 is required to send a SIP redirect message to a predefined SIP address on the Asterisk PBX. For example, FIG. 10 may represent an exemplary example of what the default UI screen 116 on Device 302-1 may look like, when SIP User Agent 301-1 is in a provisional state, and no UI_CTL_NOTIFY( ) 340 message has been yet received from Application 303. If Application 303 would like to add a Voicemail redirect softkey, it can send a UI_CTL_NOTIFY( ) 340 message that includes information such as:

<Display>

<Text>to Voicemail</Text>
<Pos>35,55</Pos>

</Display>
<Keys>

<Key>SOFTKEY_UR,REDIRECT,*200@192.168.0.50</Key>

</Keys>

In this exemplary example, this UI_CTL_NOTIFY( ) 340 message would not overwrite the complete Screen 116, but would rather add a “to Voicemail” softkey to the upper right softkey of Device 302-1. When a user presses this upper right key on Device 302-1, it would send a SIP 302 Redirect 345 message to the SIP address *200@192.168.0.50. Known to one skilled in the art, this has the effect of redirecting the incoming SIP call to SIP User Agent 301-1 back to the voicemail SIP address of the Asterisk PBX.

In a similar manner, as shown in FIG. 8, when there is no established SIP communication session, an Application 303, with SIP User Agent 301-2, can send a UI_CTL_NOTIFY( ) 340 message to SIP User Agent 301-1, resident in Device 302-1. Hence, when Device 302-1 is in an idle state, its idle screen 116 can also be modified.

It is noted that not all <Key> action items can be performed on Device 302-1 when in the provisional or idle state. For example, known to one skilled in the art, no DTMF action or call transfer events can be initiated between SIP User Agents 301-1 and 301-2 when they are in idle or provisional state. But a SIP INVITE action event would be possible when Device 302-1 is in an idle state.

For Application 303 to know the user interface characteristics of Device 302-1, or to know if Device 302-1 even supports the inventive user interface control techniques, some method of discovery of the user interface control capabilities is needed. In the preferred embodiment of the invention, a UI_CTL_NOTIFY( ) 340 message is sent with an action request. This action request would indicate that it would like to discover the user interface control capabilities. As mentioned previously, if the Device 302-1 would reply with a standard SIP 4xx error response code if it did not support this capability at all. But if Device 302-1 does support the capability, in the preferred embodiment of the invention, it can reply back with the standard 200 OK SIP 341 message, and include in the content body of the 200 OK SIP 341 message any such informative information about its user interface control capabilities. This may include information such as screen characteristics, key and indicator availability information, and any necessary information for Application 303 to understand what user interface control capabilities. Known to one skilled in the art, there are other less preferred embodiments of this discovery capability, such as looking at the SIP User Agent field in the 200 OK 341 message. Known to one skilled in the art, the SIP User Agent field provides a textual name of the SIP User Agent 301-1. This SIP User Agent field would not normally have any user interface control information, but may identify the brand or model name of Device 302-1. From this information, Application 303 may be able to deduce the user interface control capabilities of Device 302-1.

It is noted that this cooperative external control of a device user interface can pose security risks, since the Application 303 could convey sensitive information. For example, if Application 303 is a banking application interactive voice response, it may be requesting to the user of Device 302-1, such as login information. Known to one skilled in the art, it is recommended that the SIP and associated RTP communication protocols have common industry security techniques applied to these protocols.

As is known to one skilled in the art, there is provided a computer usable medium for use in a device such as Device 302-1 and Application 303, with both having computer readable program code means embodied therein, the computer readable program code means for implementing their respective operations in the inventive cooperative external control of device user interface invention.

1. A method for a first telephony network device to establish a communication session with a second telephony network device across a network for allowing either telephony network device to co-operatively control the user interface elements of the other telephony network device comprising the steps of:
a) the first telephony network device sending out a session initiation message to a predetermined device network address associated with the second telephony network device;
b) the second telephony network device receiving and responding to the session initiation message with an optional provisional response, followed by a session acceptance response message;
c) the first and second telephony network devices establishing an operative communication link between each other; and
d) wherein upon establishment of an operative communication link or during the provisional state of the communication link, either or both of the first and second telephony network devices sends one or more control messages enabling the telephony network device to co-operatively control the user interface elements of the other telephony network device.

2. A method as in claim 1 wherein each control message comprises of information that uniquely associates the control message with the established session.

3. A method as in claim 2 wherein a telephony network device, upon receiving a control message and in response to input from a user on the recipient telephony network device, the recipient telephony network device sends a response message to the other telephony network device.

4. A method as in claim 3 wherein the response message comprises at least one of a packet data representing one or more packet-based Dual Tone Modulation Frequency (DTMF) messages and general packet data message.

5. A method as in claim 1 wherein a control message comprises information that allows response messages to be generated by a recipient telephony network device upon input from a user who presses specified non-dialpad user interface elements on the recipient telephony network device.

6. A method as in claim 5 wherein the non-dialpad user interface element is at least one of a physical button and a virtual button element on a touch screen on a telephony network device.

7. A method as in claim 1 wherein a control message comprises information that allows selective user interface elements on a recipient telephony network device to be modified.

8. A method as in claim 7 wherein the user interface elements is at least one of an illuminated indicator, text representation on a screen, images on a screen, and graphical element represented on a screen.

9. A method as in claim 1 wherein a control message which comprises information that allows a recipient telephony network device to learn about the user interface control capabilities of the originating telephony network device.

10. A method as in claim 1 wherein a control message comprises information that allows response messages that are generated by a recipient telephony network device upon input from a user who presses specified user interface elements on the recipient telephony network device to be routed via the established session signalling path rather than the session media path.

11. A system, comprising:
a client telephony network device;
a server telephony network device;
and a packet network enabling real-time media communications between the two telephony network devices, wherein each telephony network device comprising:
a microprocessor operatively connected to a packet network communication interface, the microprocessor for
a) sending out a communication session initiation message to a predetermined device network address associated with another telephony network device;
b) establishing a media communication session between both telephony network devices;
c) receiving user interface control messages from one device;
d) and the recipient device will render the user interface actions expressed in the user interface control message.

12. The system of claim 11 wherein each control message comprises of information that uniquely associates the control message with the established session.

13. The system of claim 12 wherein a telephony network device, upon receiving a control message and in response to input from a user on the recipient telephony network device, the recipient telephony network device sends a response message to the other telephony network device.

14. The system of claim 13 wherein the response message comprises at least one of a packet data representing one or more packet-based Dual Tone Modulation Frequency (DTMF) messages and general packet data message.

15. The system of claim 11 wherein a control message comprises information that allows response messages to be generated by a recipient telephony network device upon input from a user who presses specified non-dialpad user interface elements on the recipient telephony network device.

16. The system of claim 15 wherein the non-dialpad user interface element is at least one of a physical button and a virtual button element on a touch screen on a telephony network device.

17. The system of claim 11 wherein a control message comprises information that allows selective user interface elements on a recipient telephony network device to be modified.

18. The system of claim 17 wherein the user interface elements is at least one of an illuminated indicator, text representation on a screen, images on a screen, and graphical element represented on a screen.

19. The system of claim 11 wherein a control message which comprises information that allows a recipient telephony network device to learn about the user interface control capabilities of the originating telephony network device.

20. The system of claim 11 wherein a control message comprises information that allows response messages that are generated by a recipient telephony network device upon input from a user who presses specified user interface elements on the recipient telephony network device to be routed via the established session signalling path rather than the session media path.
